(19) United States
(12) Patent Application Publication
(10) Pub. No.: US 2015/0289573 A1
(43) Pub. Date: Oct. 15, 2015

(54) SELF SANITIZING FACE MASKS AND METHOD OF MANUFACTURE

(71) Applicant: Marci B. Haas, Ft. Lauderdale, FL (US)

(72) Inventor: Marci B. Haas, Ft. Lauderdale, FL (US)

(21) Appl. No.: 14/751,695

(22) Filed: Jun. 26, 2015

Related U.S. Application Data
(63) Continuation of application No. 11/757,336, filed on Jun. 1, 2007, now abandoned.

(51) Int. Cl. A41D 13/11; B29C 70/88; B29C 70/06; A62B 23/02

(52) U.S. Cl. CPC A41D 13/1192; A62B 23/025; B29C 70/88; B29C 70/06; B29L 2031/14

(57) ABSTRACT

A reusable facemask includes a filter layer of material adapted to trap particles having a size range of known contaminant particles; and a porous layer of material located adjacent to the filter layer and adapted to continually sanitize contaminant particles trapped by the filter layer and contaminant particles passing through the porous layer by releasing free ions of elements selected from the group consisting of silver and copper.

### FIELD OF THE INVENTION

The present invention generally relates to facemask respirators, and in particular, to such respirators which are self sanitizing and thereby reusable.

### BACKGROUND OF THE INVENTION

Disposable and non-disposable face masks and respirators for filtering breathed air have been in use for many years. In the medical field, many early masks were used to prevent contamination and resulting infection of patients, particularly during surgery. Face masks are worn for many hours in some instances. In recent years, there has also been an increased awareness and concern for preventing contamination and infection of the public and health care personnel by airborne pathogens. Therefore, it has become necessary to prevent the spread of infections from person to person, from patient to health care worker and vice versa by preventing inhalation or exhalation of airborne infectious aerosols and/or particulate matter.

In particular, with the outbreak of the SARS virus, the spread of such airborne pathogens and has become even a greater concern on the minds of public health officials because its potential impact.

An N-95 respirator is one of nine types Of disposable particulate respirators. Particulate respirators are also known as “air-purifying respirators” because they protect by filtering particles out of the air as you breathe. These respirators protect only against particles, not gases or vapors. Since airborne biological agents such as bacteria or viruses, are particles, they can be filtered by particulate respirators. Respirators that filter out at least 95% of airborne particles during “worse case” testing using a “most-penetrating” sized particle are given a 95 rating. Those that filter out at least 99% receive a “99” rating. And those that filter at least 99.97% (essentially 100%) receive a “100” rating. Respirators in this family are rated as N, R, or P for protection against oils. This rating is important in industry because some industrial oils can degrade the filter performance so it doesn't filter properly. Respirators are rated “N,” if they are not resistant to oil, “R” if somewhat resistant to oil, and “P” if strongly resistant (oil proof). Thus, there are nine types of disposable particulate respirators: N95, N-99, and NIOO; R-95, R-99, and R-IOO; P-95, P-99, and P-IOQ. NIOSH uses very high standards to test and approve respirators for occupational uses. NIOSH-approved disposable respirators are marked with the manufacturer's name, the part number (PIN), the protection provided by the filter (e.g., N-95), and “NIOSH.” This information is printed on the facepiece, exhalation valve cover, or head straps. A listing of all NIOSH-approved disposable respirators is published online at http://www.cdc.gov/niosh/npptl/respirators/disp_part/particlist.html. If a disposable respirator does not have these markings and does not appear on one of these lists, it has not been certified by NIOSH. NIOSH also maintains a database of all NIOSH-approved respirators regardless of respirator type (the Certified Equipment List) that can be accessed at (http://www.cdc.gov/nioshlcelintrol.html]). More detailed respirator information has been published by NIOSH, CDC, at http://www.cdc.gov/niosh/respinfo.html and the Occupational Safety and Health Administration (OSHA) at http://www.osha.gov/SLTC/etools/respiratory/index.html.

### SUMMARY OF THE INVENTION

The subject invention concerns face masks, including surgical masks and respirator masks, that comprise components that exhibit self sanitizing properties.

One embodiment of the present invention provides a reusable facemask, comprising: a filter layer of material adapted to trap particles having a size range of known contaminant particles; and a porous layer of material located adjacent to the filter layer and adapted to continually sanitize contaminant particles trapped by the filter layer and contaminant particles passing through the porous layer by releasing free ions of elements selected from the group consisting of silver and copper.

The facemask may further comprise a second porous layer adapted to release free ions of elements selected from the group consisting of silver and copper and adapted to than an inside surface of the mask shaped to contact the face of a wearer of the mask. The facemask may further comprise a second filter layer located adjacent and in contact with the first said inner filter layer. The outer porous layer, the inner filter layer, and the second porous layer may be sandwiched together and molded to shape the facemask respirator. The shape of the mask may be heat molded.

The porous layer may include zeolite carriers embedded at the surface of fibers and adapted to release free ions of elements selected from the group consisting of silver and copper to sanitize contaminant particles trapped in the inner filter layer and particles located within the vicinity of the porous layer. The zeolite carriers may hold silver and copper.

The outer porous layer may be adapted to sanitize contaminant particles including bacteria and viruses. The outer porous layer and the inner filter layer may be scaled together around a periphery to form the facemask respirator. The filter layer may he located inside of the porous layer when the mask is worn to protect the wearer from airborne contaminants. The filter layer may be located outside of the porous layer when the mask is worn to retain airborne contaminants exhaled by the wearer.

Another embodiment of the present invention provides a method for protecting a person from airborne contaminant exposure, comprising the steps of: filtering breathing air for a person with a filter adapted to trap particles having a size range of known contaminant particles; and continually sanitizing particles trapped in the filter by continually releasing ions of elements selected from the group consisting of silver and copper, in the vicinity of particles trapped in the filter and particles located in the vicinity of the filter.

The steps of filtering and exposing may be performed by a face mask. The step of exposing may be performed by a first layer of material located on the face mask. The step of filtering may be performed by a second layer of material located adjacent the first layer in the face mask in a position to filter either incoming air or outgoing air which has already passed through the first layer.

The method may further comprise the step of rendering the mask reusable by continually releasing free ions to sanitize the mask over time. The continually releasing of ions may be performed by zeolite carriers holding silver and copper.

Yet another embodiment of the present invention provides a method of manufacturing a reusable facemask respirator, comprising the steps of: combining a filter layer of material adapted to trap particles having a size range of known contaminant particles and an porous layer of material adapted to continually sanitize contaminant particles by releasing free ions of silver and copper; and sealing the filter layer and the porous layer together around a periphery shaped to form a face mask.

The step of combining may include adding a second porous layer adapted to release ions of silver and copper and located on an opposite side of the filter layer form the first said porous layer. The step of combining may include adding a second filter layer located adjacent and in contact with the first said filter layer. The method may further comprise the steps of sandwiching together the outer porous layer, the inner filter layer, the second filter layer and the second porous layer and molding the sandwiched layers to shape the facemask respirator. The step of molding may include heat molding.

Still another embodiment of the present invention provides a facemask, comprising: a plurality of sanitizing layers oriented to cause air breathed by a wearer of the mask to pass through each layer of the plurality of sanitizing layers, wherein each of the sanitizing layers is comprised substantially of fibrous material having zeolite carriers holding silver and copper embedded and partially exposed at surfaces of fibers in the fibrous material to provide the release of free ions of silver and copper, and further wherein the fibrous material is adapted to provide a sufficient density of exposed silver and copper and sufficient air turbulence to promote contact between contaminants in breathing air flowing through the plurality of sanitizing layers.

The fibrous material may consist essentially of fibers having zeolite carriers holding silver and copper exposed at the surfaces thereof The fibrous material may have a minimized fiber spacing.

Advantageously, the masks and filtration materials of the invention can be washed and reused while retaining their antimicrobial activity and/or filtration capability. In one embodiment, material used in the filter elements of the mask have antimicrobial properties. The material can contain or be produced, coated, or impregnated with a composition or compound that has antimicrobial activity. In one embodiment, the composition or compound comprises silver and/or copper ions. Compounds comprising silver and/or copper ions that are useful in the present invention include a zeolite carrier that contains silver and/or copper ions. The zeolite carrier provides for controlled and effective release of the silver and/or copper ions.

### BRIEF DESCRIPTION OF THE DRAWINGS

For a beater understanding of the present invention, together with other and further objects thereof, reference is made to the accompanying drawing and detailed description, wherein:

FIG. 1 shows a perspective depiction of a molded face mask being worn;

FIG. 2 is a perspective depiction of a fold flat facemask being worn;

FIG. 3 is a illustration of the various layers used to construct the facemask of FIG. 1 in accordance with one embodiment of the present invention;

FIG. 4 shows a zeolite carrier containing silver or copper ions that can be used in the construction of the facemasks of FIGS. 1-3;

FIG. 5 shows a cross-section of a bi-component core and sheath fiber containing zeolite carrier with copper and silver ions that can be used in construction of the facemasks of FIGS. 1-3;

FIG. 6 shows a multiplicity of fibers having exposed zeolites carriers on the surface there of for use in the construction of the facemasks of FIGS. 1-3.

### DETAILED DESCRIPTION OF THE INVENTION

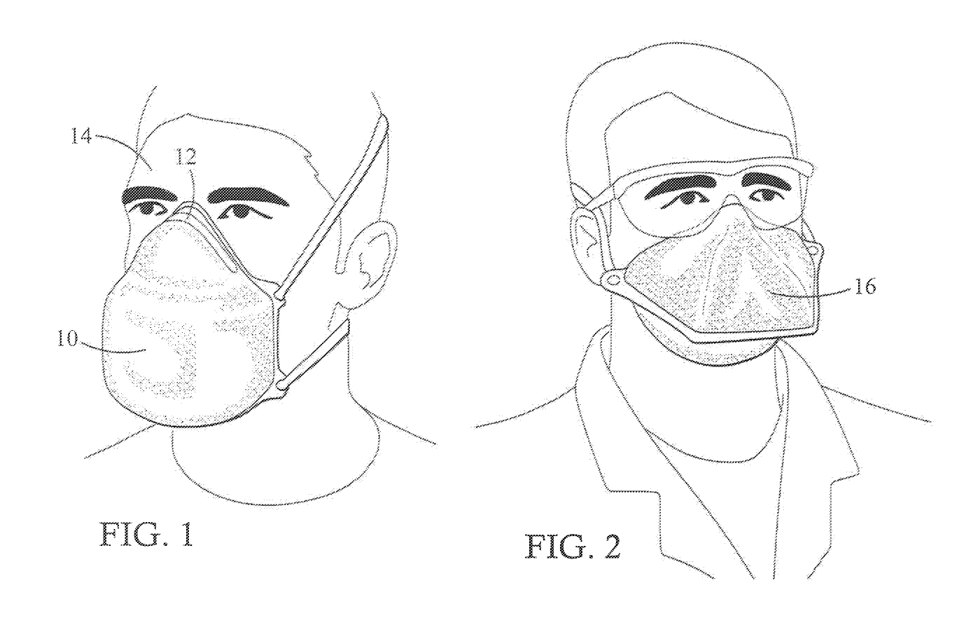

The facemask of the present invention may take various forms, such as those illustrated in FIGS. 1 and 2. The facemask 10 of FIG. 1 is a molded variety having a bendable metal reinforcement nose bar 12 to allow custom fitting of the mask 10 around the nose of a wearer 14. The facemask 16 of FIG. 2 is commonly referred to as a fold-flat or duck bill mask. Either of the masks 10 and 16 shown in FIGS. 1 and 2 is suitable for use with the present invention as are various other mask embodiments. The term contaminants used herein is intended to cover pathogens as well as any particulates sought to be filtered from breathing air.

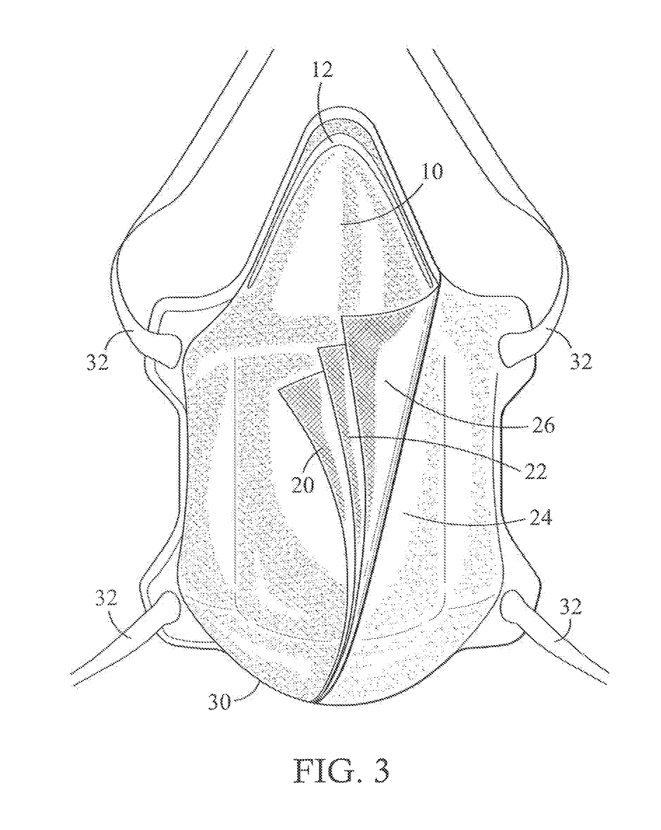

Mask 10 is shown in further detail in FIG. 3 to be constructed of multiple layers 20, 22, 24, 26, which serve different functions. Layers 22 and 26 are typically filter layers made from material adapted to trap particles having a size range of known contaminants or pathogens. The material of filter layers 22, 26 may be chosen in response to the specific contaminants or pathogens sought to be retained. Further, layers 22 and 26 may have different filtering specifications, such that one layer filters larger particles and the other layer filters the specific smaller particles of interest. This arrangement may affect various performance parameters of the mask 10.

Layers 20 and 24 are intended to be more porous than filter layers 20, 26 and are intended to he constructed to continually sanitize contaminant particles trapped by filter layers 22, 26. In addition, the action of layers 20, 24 may also serve to sanitize contaminants passing there through prior to reaching filter layers 22, 26.

The layers 20, 22, 24, 26 of mask 10 may be molded together in the shape shown in FIG. 3 by any suitable process. One such suitable process may be heat molding. Various heat multiple materials such as PET may he incorporated into the construction of layers 20, 24 by known methods to facilitate this shape molding process. The layers 20, 22, 24, 26 may be sealed together around a periphery 30 thereof by any suitable means, such as ultrasonic welding. Straps 32 may be attached to suitably hold mask 10 on a wearer's face.

The use of four layers 20, 22, 24, 26 as shown in FIG. 3 is illustrative and may vary depending upon the specific application and its performance specifications. For example, it may be useful to construct a mask using only a single filter layer 22 and only a single porous layer 20, such that the filter layer 22 is located closer to the wearer than porous layer 20. Such an arrangement would provide a simple respirator mask which filters particulate contaminants and sanitizes them to protect the wearer of the mask. Likewise, a simplified mask may be constructed just using filter layer 26 and porous layer 24, such that porous layer 24 is located closer to the wearer of such a mask. This arrangement would provide a surgical type mask which would trap and sanitize contaminants being exhaled by the mask wearer. It should also be kept in mind that the porous layers 20 and 24 may be used in combination with one or more filter layers 22, 26, as shown, to provide a mask suitable for serving either as a respirator mask or a surgical mask.

It should further be kept in mind that the multiple layers of mask 10 may be used in various flexible and non-molded arrangements in the same manner described above, to form the fold flat mask 16 shown in FIG. 2.

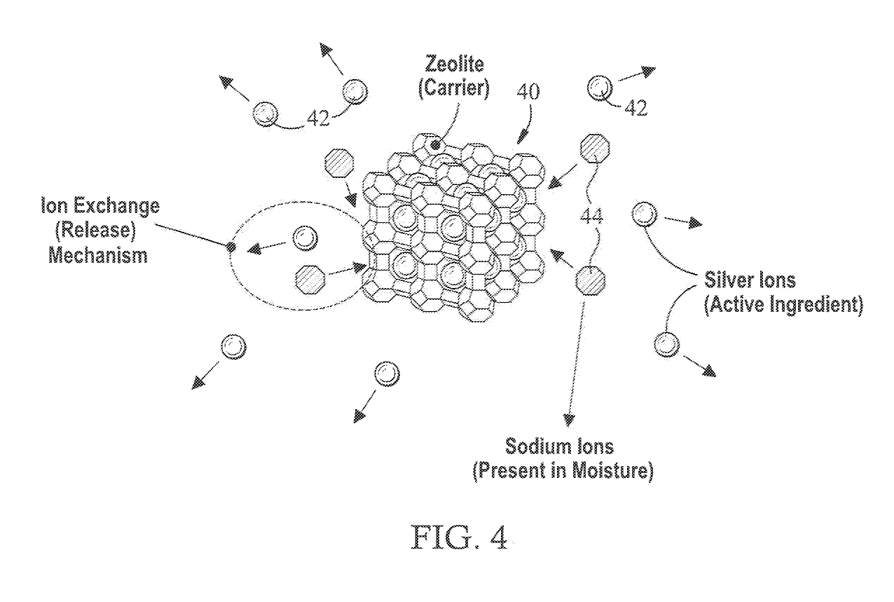

The sanitizing function of the present invention may be performed by any suitable means and preferably by the use of free ions of silver and copper, which free ions are provided from one or more of the porous layers 20, 24. In a preferred embodiment, the free ions of silver and copper are provided by atoms of silver and copper located at the outer surfaces of fibers used to construct porous layers 20, 24. Such fibers may be constructed in accordance with in U.S. Pat. Nos. 6,723,428; 6,841,244; and 6,946,196, which employ zeolite carriers holding silver and copper atoms and embed those zeolite carriers at the surface of the fibers. An example of the zeolite carriers used in those patents is shown in FIG. 4, wherein a carrier 40 enclosing atoms of silver and or copper releases free ions 42 of silver or copper in the presence of sodium ions 44 typically occurring in moisture in the air. Zeolite carrier 40 may be constructed to contain either silver or copper atoms and mixed with the zeolite carriers having the other metal atoms during construction of the fiber.

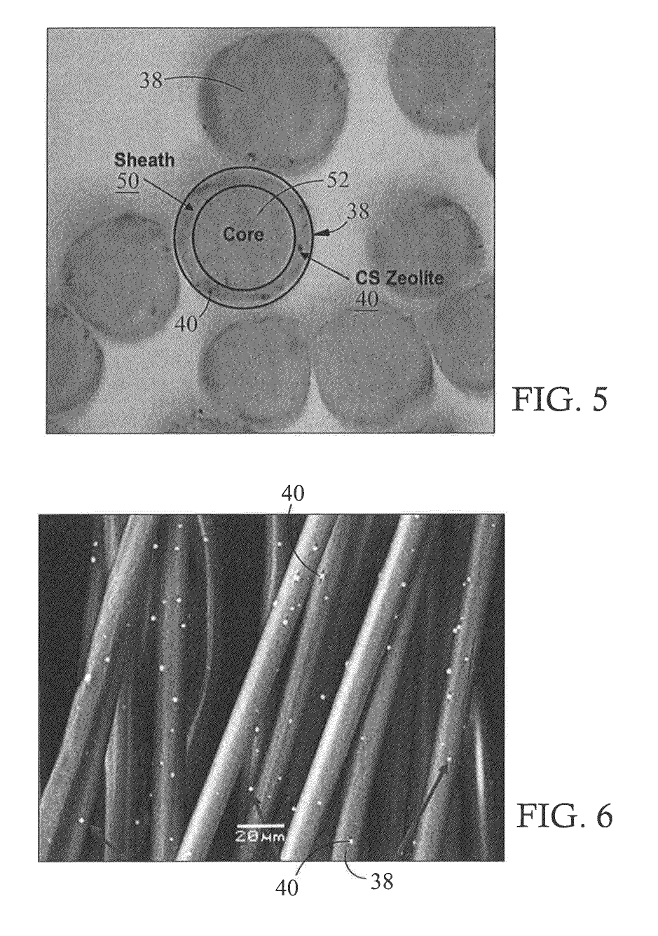

Incorporation of carriers 40 into fibers 38 is depicted in FIG. 5, which shows cross-sections of various fibers 38 with zeolite carriers 40 located in a peripheral band or sheath 50 around a central core 52 of each fiber 38. FIG. 6 further shows a depiction of such fibers having carriers 40 exposed along the outer surfaces thereof.

It is appreciated from the description of masks 10 and 16 in FIGS. 1-3 above and the description of the sanitizing function in reference to FIGS. 4-6, that the filtering function works in combination with the sanitizing function such that particles trapped in the filter layers are exposed to free ions of silver and copper over time to ensure that the sanitizing function continues indefinitely. In this manner, facemasks constructed in accordance with the different embodiments of the present invention are reusable, because of the continued sanitizing function. The sanitizing fabric as described in the prior art patents cited above is also known for being washable to provide further recycling qualities two items constructed there from.

It is also appreciated that a suitable mask having multiple layers, such as mask 10 in FIGS. 1 and 3, may be effective in protecting a wearer from various infectious contaminants simply by the sanitizing function found in porous layers 20, 24. It is understood that various amounts or thicknesses of sanitizing fabric made from the fibers described above may be constructed in a manner which causes provides exposure of substantial amounts of zeolite carriers and the free ions generated there from, along with substantial turbulence generated in air flowing through such additional thicknesses so as to greatly improve the probability of interaction between infectious contaminants and the free ions to potentially protect a wearer of the mask. In this manner, protection may be provided by a mask which does not filter, per se, to the specific size of the contaminants of interest.

In the manner described above, the embodiments of the present invention have microbial properties. The filtration materials can also contain or be produced, coated, or impregnated with a composition or compound that has antimicrobial activity. In one embodiment, the composition or compound comprises silver and/or copper ions. Silver and copper ions effectively inhibit microbial growth by interfering with cell wall transport function (respiration), cell division, and cell energy generation. Compounds comprising silver and/or copper ions that are useful in the present invention include a zeolite carrier that contains silver and/or copper ions. The zeolite carrier, such as an inorganic alumino silicate, provides for controlled and effective release (e.g., ion exchange) of the silver and/or copper ions.

In one embodiment, as water or water vapor, such as that in breathed air, passes through the filter element, the silver and copper ions are released. Suitable silver and/or copper zeolite compositions have been described in U.S. Pat. Nos. 6,436,422 and 6,866,859 and can be prepared using standard materials and methods known in the art and are also commercially available from, for example, AgION Technologies, Inc., Wakefield, Mass. Optionally, the non-filtering materials of the masks and respirators of the invention can also contain or be produced, coated, or impregnated with a composition or compound that has antimicrobial activity as described herein.

Masks and respirators contemplated within the scope of the present invention include both disposable and non-disposable masks and respirators, and include masks and respirators, and filter materials thereof, that can be reused and washed and still retain antimicrobial activity and/or filtration capability. A face mask or respirator of the invention includes those that cover a health care personnel's, patient's, or a person's (hereinafter “wearer” or “wearer's”) nose or mouth, and even preferably, a portion of the wearer's face, i.e., cheeks, jaw, chin, and so forth. In one embodiment, a respirator contemplated for use in the subject invention is an N95, N-99, N-100, R-95, R-99, R100, P-95, P-99, or PI00 respirator. In a specific embodiment, the respirator is an N-95 respirator.

As described above, a fiber used in a filtration material of a mask or respirator of the present invention comprises an outer sheath layer surrounding an inner core. Examples of fibers suitable for use with the present invention are described in U.S. Pat. Nos. 6,723,428; 6,841,244; and 6,946,196. In a specific embodiment, a composition or compound comprising a zeolite carrier containing silver and/or copper ions is embedded or attached to the sheath layer of the fiber. An example of a fiber having an outer sheath surrounding an inner core and containing zeolite carrier containing silver and/or copper ions is manufactured by Foss Manufacturing Company, Inc., Hampton, N.H.). Masks and respirators of the invention can also comprise fibers that do not have antimicrobial properties (non-antimicrobial fibers) in addition to fibers that do have antimicrobial properties. The blend of antimicrobial fibers to non-antimicrobial fibers in a mask or respirator can be in any ratio.

The fibers contemplated for use in the masks and respirators of the invention can be made of natural materials, such as cotton, paper, and the like, and/or synthetic materials, such as polyethylene, polyester, nylon, rayon, and the like. The fibers used in the present invention can be woven into any suitable material or fabric, or they can be spun-bonded, melt blown, pressed, matted, glued, or otherwise formed into a material or fabric.

As used herein, the term “antimicrobial” refers to killing activity or inhibition or prevention of growth or replication of bacteria, virus, fungi, yeast, mold, and mildew. Bacteria that can be killed or inhibited by the present invention include, but are not limited to, Bacillus cereus, Bacillus thuringiensis, Mycobacterium tuberculosis, Legionella pneumophila, Escherichia coli, Klebsiella Pneumoniae, Salmonella gallinarum, Salmonella typhimurium, P. gingivalis, Staphylococcus aureus, Staphylococcus epidermis, Streptococcus faecalis, Streptococcus agalactiae, Streptococcus Pseudomonas aeruginosa, Listeria mutans, monocytogenes, Proteus mirabilis, Proteus vulgaris, Vibrio parahaemolyticus, Enterobacter aerogines, Trichophyton malmsten, and Chactomium globosum. Yeast and mold that can be killed or inhibited by the present invention include, but are not limited to, Stachybotrys, Aspergillus niger, Candida albicans, Pencillium funiculosum, Gliocladum virens, Aureobasidium pullulans, and Saccharomyces cerevisiae. Viruses that can be killed or inhibited by the present invention include, but are not limited to, SARS virus (SARS-associated coronavirus, influenza virus (including avian influenza), filoviruses (Marburg and Ebola), hantavirus, and mv virus.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this invention as defined in the appended claims.

1. A reusable facemask, comprising:
a filter layer of material sized to filter out and trap particles having a size range of known contaminant particles; and
a porous layer of material located adjacent to the filter layer and adapted to continually sanitize contaminant particles trapped by the filter layer and contaminant particles passing through the porous layer by releasing free ions of elements selected from the group consisting of silver and copper.

2. The facemask of claim 1, further comprising a second porous layer adapted to release free ions of elements selected from the group consisting of silver and copper and located on an opposite side of the filter layer from the first said porous layer to form an inside surface of the mask shaped to contact the face of a wearer of the mask.

3. The facemask of claim 2, further comprising a second filter layer located adjacent and in contact with the first said filter layer, wherein the first said filter layer and the second filter layer trap and filter out different sizes of particles.

4. The face mask of claim 2, wherein the first said porous layer, the filter layer, and the second porous layer are sandwiched together and molded to shape the facemask respirator.

5. The facemask of claim 4, wherein the shape of the mask is heat molded.

6. The facemask of claim 1, wherein the porous layer includes zeolite carriers embedded at the surface of fibers and adapted to release free ions of elements selected from the group consisting of silver and copper to sanitize contaminant particles trapped in the inner filter layer and particles located within the vicinity of the porous layer.

7. The facemask of claim 6, wherein the zeolite carriers hold silver and copper.

8. The facemask of claim 1, wherein the porous layer is adapted to sanitize contaminant particles including bacteria and viruses.

9. The facemask of claim 1, wherein the first said porous layer and the filter layer are sealed together around a periphery to form the facemask respirator.

10. The facemask of claim 1, wherein the filter layer is located inside of the porous layer when the mask is worn to protect the wearer from airborne contaminants.

11. The facemask of claim 1, wherein the filter layer is located outside of the porous layer when the mask is worn to retain airborne contaminants exhaled by the wearer.

12. A method for protecting a person from airborne contaminant exposure, comprising the steps of
filtering breathing air for a person with a filter sized to filter out and trap particles having a size range of known contaminant particles; and
continually sanitizing particles trapped in the filter by continually releasing ions of elements selected from the group consisting of silver and copper, in the vicinity of particles trapped in the filter and particles located in the vicinity of the filter.

13. The method of claim 12, wherein the steps of filtering and sanitizing are performed by a face mask.

14. The method of claim 13, wherein the step of sanitizing is performed by a first layer of material located on the face mask.

15. The method of claim 14, wherein the step of filtering is performed by a second layer of material located adjacent the first layer in the face mask in a position to filter either incoming air or outgoing air which has already passed through the first layer.

16. The method of claim 12, further comprising the step of rendering the mask reusable by continually releasing free ions to sanitize the mask over time.

17. The method of claim 12, wherein the continually releasing of ions is performed by zeolite carriers holding silver and copper.

18. A method of manufacturing a reusable facemask respirator, comprising the steps of:
combining a filter layer of material adapted to filter out and trap particles having a size range of known contaminant particles and a porous layer of material adapted to continually sanitize contaminant particles by releasing free ions of silver and copper; and
sealing the filter layer and the porous layer together around a periphery shaped to form a face mask.

19. The method of claim 18, wherein the step of combining includes adding a second porous layer adapted to release ions of silver and copper and located on an opposite side of the filter layer from the first said porous layer.

20. The method of claim 19, wherein the step of combining includes adding a second filter layer located adjacent and in contact with the first said filter layer, and further wherein the first said filter layer and the second filter layer tray and filter out different sizes of particles.

21. The method of claim 20, further comprising the steps of sandwiching together the first said porous layer, the filter layer, the second filter layer and the second porous layer and molding the sandwiched layers to shape the facemask respirator.

22. The method of claim 21, wherein the step of molding includes heat molding.

23. (canceled)

24. (canceled)

25. (canceled)

26. (canceled)
